(19) United States
(12) Patent Application Publication
(10) Pub. No.: US 2009/0322550 A1
(43) Pub. Date: Dec. 31, 2009

(54) WIRELESS HOME CONTROL SYSTEM

(75) Inventor: Hung-Huei YU, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/145,904

(22) Filed: Jun. 25, 2008

(51) Int. Cl. G08C 19/02

(52) U.S. Cl. 340/825.69

(57) ABSTRACT

A wireless home control system to perform wireless control operation of at least one home appliance through a control code includes a controlling integrated module and a signal transfer controller linking the home appliance and the controlling integrated module in a wireless transmission mode. The controlling integrated module includes a control code saving unit to store the control code. The signal transfer controller includes a display unit and an input interface linking to the display unit. The input interface generates a request signal sent to the controlling integrated module to receive the corresponding control code in the control code saving unit. The control code is sent to the home appliance in the wireless transmission mode through the signal transfer controller to perform the control operation. Thus users can operate the signal transfer controller to output the control code to control the home appliances.

### FIELD OF THE INVENTION

The present invention relates to a wireless home control system and particularly to a home control system to control a plurality of home appliances wirelessly.

### BACKGROUND OF THE INVENTION

The capability of controlling home appliances in a wireless and remote fashion has provided a great convenience to many people in life. Through a wireless remote controller, people can do remote operation without directly accessing the host of a home appliance. For instance, to see video programs or listen music through on a video equipment, users can sit on a comfortable location to play the video or adjust the sound volume through the remote controller. In another instance, for an air conditioner installed on a higher location in a room, users can adjust the temperature through a remote controller without climbing to save trouble or avoid the risk of falling.

Although the wireless remote control technique provides great convenience to people, there is no common rule or transmission protocol on the market. Different home appliances have to use dedicated remote controllers. The remote controllers are different even on the same type of home appliance for different producers or product families, and are not compatible. As a result, there could be many different types of remote controllers in one house to suit different types of home appliances. To remedy this problem, a universal remote controller or integrated remote controller (called universal remote controller in short hereinafter) applicable to multiple and different types of home appliances has been developed. The conventional universal remote controller has a control code storage to save control codes of many types of home appliances. When in use and a user depresses a corresponding operation key on the remote controller, a corresponding control code is sent to an intended home appliance through a wireless transmission module. However, the targets controllable by the conventional universal remote controller are limited by the control code number saved in the control code storage and configuration of the operation key. It does not fully provide universal remote control function for all types of home appliances. R.O.C. U.S. Pat. Nos. 456,112, 559,413 and 1,292,116 disclose learning universal remote controllers equipped with a touch screen which has touch segments that can be adjusted or defined according to different home appliances to generate multiple touch control pages. As they are provided with learning function, they can be mated to different types of home appliances to get and save corresponding control codes. Hence they overcome the problem of incomplete control codes in the control code storage. Furthermore, R.O.C U.S. Pat. Nos. 559,413 and application No. 200805900 disclose a universal remote controller which has a control code storage that can be updated by downloading through a network to expand the applicable home appliances on wireless remote control function.

However, while the learning universal remote controller equipped with the touch screen previously discussed can perform remote operation for many types of home appliances, it has to rely on a great deal of complex electronic elements, and almost becomes a small computer equipped with processing capability. Hence production cost is higher and the size is bigger.

### SUMMARY OF THE INVENTION

The primary object of the present invention is to provide a wireless control system to control a plurality of home appliances through one single remote controller. It is made in a compact size but can provide multiple functional controls without comprising the basic convenience of the remote controller. To achieve the foregoing object, the invention provides a wireless home control system capable of controlling at least one home appliance in a wireless fashion through a control code. It includes a controlling integrated module and a signal transfer controller linking in a wireless transmission mode the home appliance and the controlling integrated module. The controlling integrated module has a control code saving unit to store the control code. The signal transfer controller has a display unit and an input interface linking to the display unit. The input interface generates a request signal sent to the controlling integrated module to get the corresponding control code in the control code saving unit. The control code is sent to the home appliance through the signal transfer controller to perform control operation.

The home appliance, signal transfer controller and controlling integrated module are linked by a wireless transmission module in a wireless transmission mode. In this invention, the input interface may be a physical control key or a touch screen integrated with the display unit. The display unit receives video information from the controlling integrated module through the wireless transmission mode.

In one aspect, the control codes sent to the home appliance and obtained from the control code saving unit may be the same or a first control code and a second control code that are different. The first and second control codes are converted through a control code conversion unit located in the signal transfer controller.

According to another embodiment of the invention, the home appliance has a signal processing unit to generate a feedback signal which is sent to the controlling integrated module through the signal transfer controller in the wireless transmission mode. The feedback signal generated by the signal processing unit and another feedback signal received by the controlling integrated module can be the same or a first feedback signal and a second feedback signal that are different. The first feedback signal and the second feedback signal are converted by a control code conversion unit located in the signal transfer controller. The display unit receives the video information from the home appliance in the wireless transmission mode.

Thus through the wireless home control system of the invention, users can maneuver the input interface on the signal transfer controller to get the control code through the controlling integrated unit of a home appliance on which operational control is intended. The control code is sent to the home appliance through in wireless transmission mode to do operation desired. Hence the signal transfer controller can provide multiple control functions without being loaded with too much or complicated electronic elements. On the other hand, the control code stored in the control code saving unit can be transmitted wirelessly to the home appliance through the signal transfer controller, and the feedback signal generated by the home appliance can also be sent to the controlling integrated unit through the signal transfer controller to achieve a two-way communication function between the home appliance and the controlling integrated unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic structural block diagram of a first embodiment of the wireless home control system of the invention.

FIG. 2 is a schematic structural block diagram of a second embodiment of the wireless home control system of the invention.

FIG. 3 is a schematic structural block diagram of a third embodiment of the wireless home control system of the invention.

FIG. 4 is a schematic view of a physical structure of an embodiment of the wireless home control system of the invention.

FIGS. 5A through 5D are schematic views of a control procedure of an embodiment of the wireless home control system of the invention.

FIG. 6 is a schematic structural block diagram of an embodiment of the wireless home control system of the invention in a two-way communication mode.

FIG. 7 is a schematic view of a physical structure of an embodiment of the wireless home control system of the invention in a two-way communication mode.

### DETAILED DESCRIPTION OF THE PREFERRED EMBODIMENTS

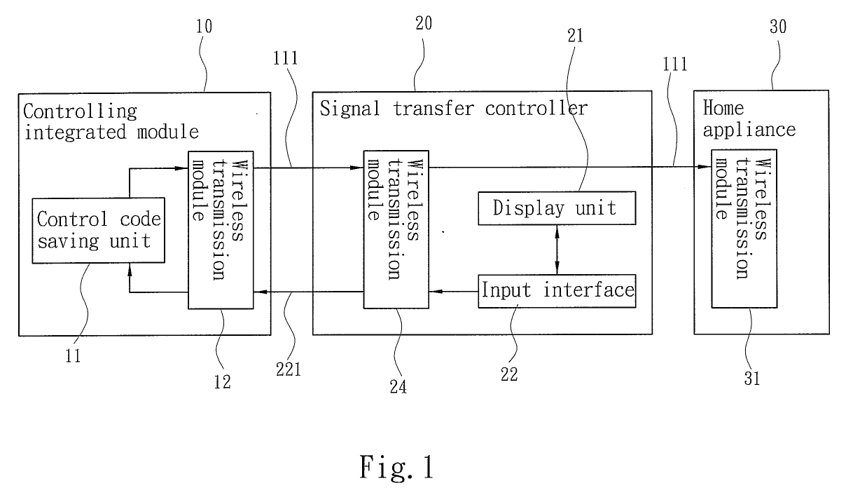

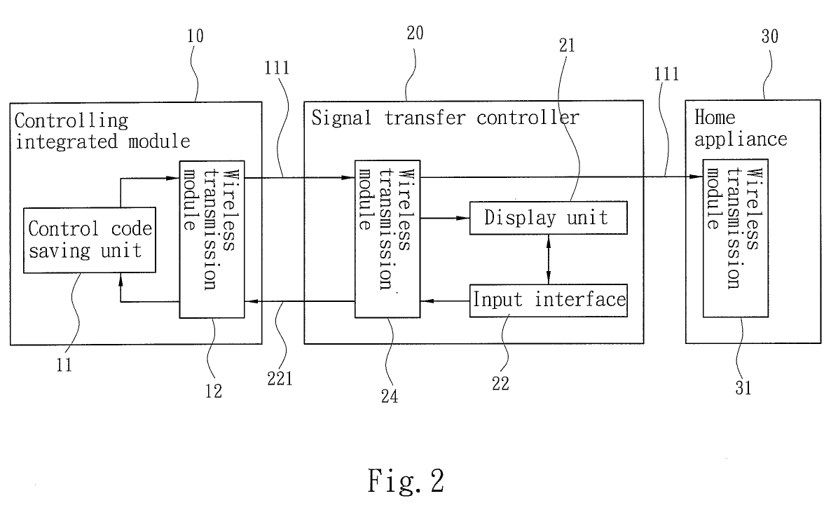

Please refer to FIG. 1 for the structure of an embodiment of the invention. A wireless home control system of the invention aims to control at least one home appliance 30 through a control code 111 in a wireless fashion. It includes a controlling integrated module 10 and a signal transfer controller 20 linking the home appliance 30 and the controlling integrated module 10. The controlling integrated module 10 has a control code saving unit 11 to store the control code 111. The signal transfer controller 20 has a display unit 21 and an input interface 22 linking to the display unit 21. The input interface 22 generates a request signal 221 sent to the controlling integrated module 10 to get the corresponding control code 111 in the control code saving unit 11, and send the control code 111 in a wireless transmission mode to the home appliance 30 through the signal transfer controller 20 to do control operation. The home appliance 30, signal transfer controller 20 and controlling integrated module 10 are linked together through wireless transmission modules 12, 24 and 31. The control code 111 of the home appliance 30 in the control code saving unit 11 can be updated externally, such as through a network, diskette or other storage devices. The display unit 21 receives video information from the controlling integrated module 10 in the wireless transmission mode (such as through the wireless transmission modules 12 and 24, also referring to FIG. 2).

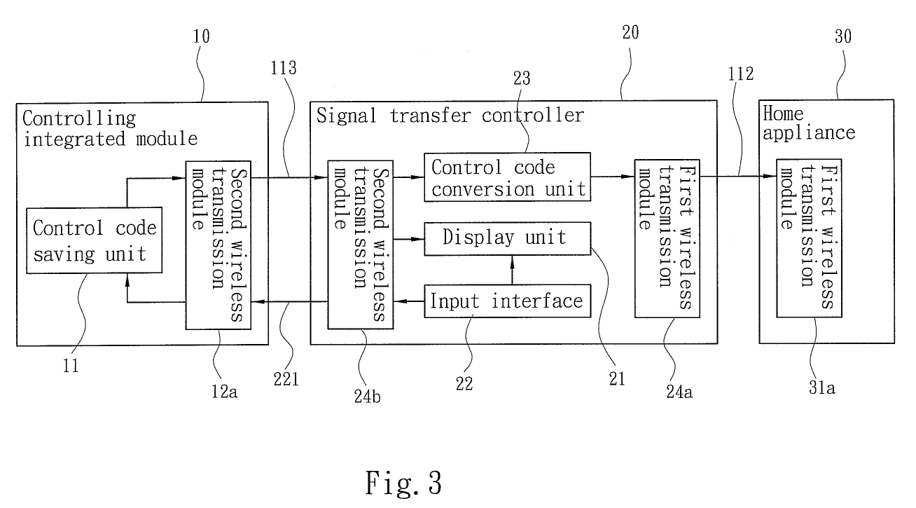

In the invention, the control code 111 sent to the home appliance 30 and the control code 111 received from the control code saving unit 11 can be the same (referring to FIGS. 1 and 2), or be a first control code 112 and a second control code 113 (referring to FIG. 3) that are different. The first and second control codes 112 and 113 are converted through a control code conversion unit 23 located in the signal transfer controller 20. The home appliance 30 and the signal transfer controller 20 have respectively a first wireless transmission module 31a and 24a to provide communication of the first control code 112. The controlling integrated module 10 and the signal transfer controller 20 have respectively a second wireless transmission module 12a and 24b to provide communication of the second control code 113. The first control code 112 and the second control code 113 can conform to different signal protocols. For instance, the first control code 112 may be an analog signal, while the second control code 113 may be a digital signal. Hence some home appliances 30 cannot directly receive the second control code 113 to operate as desired. When the signal transfer controller 20 receives the second control code 113 through the second wireless transmission modules 12a and 24b, the control code conversion unit 23 converts it to the first control code 112 readable by the home appliance 30, then is sent to the home appliance 30 through the first wireless transmission modules 31a and 24a. The control code conversion unit 23 may be a decoder.

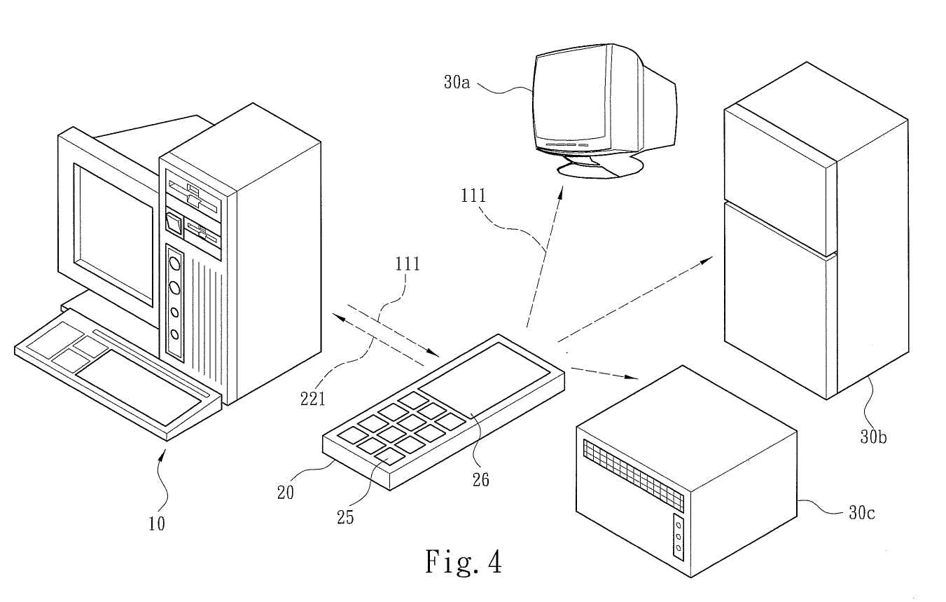

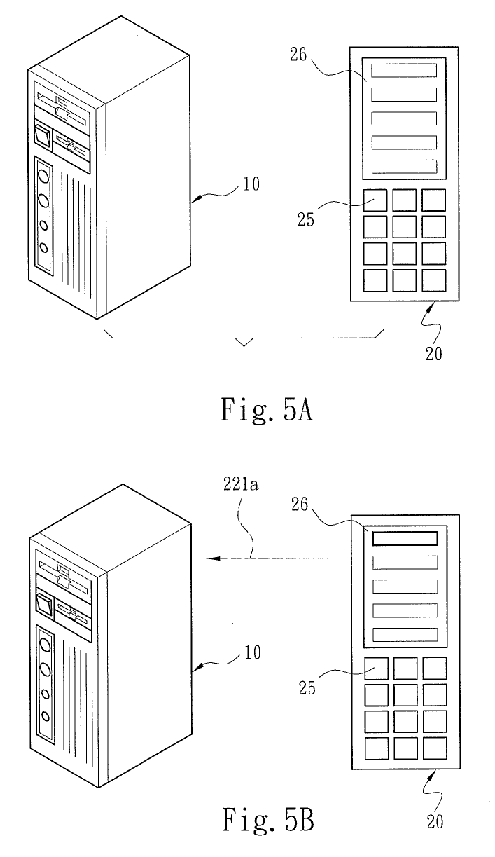

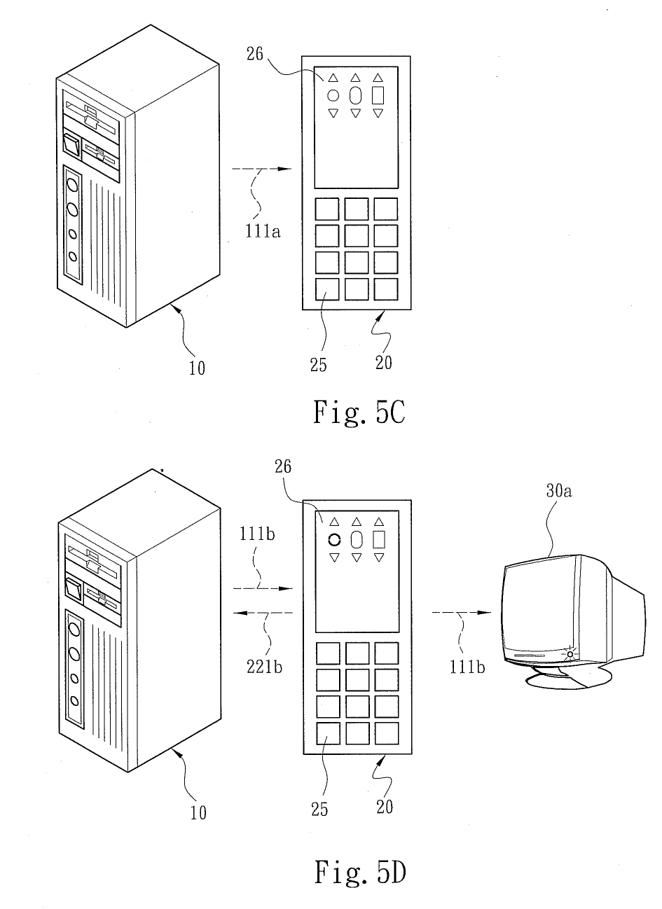

Refer to FIGS. 4, 5A through 5D and also FIG. 1 for a physical structure and processing procedure of the embodiment of the invention. When in use and a user wants to operate the home appliance 30 (the home appliance 30 is a generally used household appliance such as a multimedia video system, air conditioner, refrigerator 30a, 30b and 30c or the like), he/she can do the operation on the signal transfer controller 20. The input interface 22 of the signal transfer controller 20 may be a physical control key 25. The input interface 22 may also be integrated with the display unit 21 to become a touch screen 26. The signal transfer controller 20 is not limited to a general controller, but may be a mobile communication device (such as a handset, PDA or the like) or other portable electronic device. The controlling integrated module 10 may be located in a computer system such as a personal computer, notebook computer or the like, or an independent device.

The signal transfer controller 20 can get a control menu built-in or through the controlling integrated module 10 so that the user can make selection according to the menu to control the intended home appliances 30a, 30b or 30c. By depressing the touch screen 26 or physical control key 25 a selected command can be executed as shown in FIG. 5A. The input interface 22 of the touch screen 26 or physical control key 25 generates a primary request signal 221a in the controlling integrated module 10 as shown in FIG. 5B. The control code saving unit 11 in the controlling integrated nodule 10 outputs a primary control code 111a responding to the primary request signal 221a and allows the touch screen 26 or display unit 21 to display a corresponding control picture of the home appliance 30a as shown in FIG. 5C. In this embodiment the appliance 30a is a TV set, and the control picture is a control block diagram for displaying switches, sound volume, channel selection and the like as shown in FIG. 5D. The user can further select a different control block diagram through the touch screen 26 or physical control key 25, then send a secondary request signal 221b to the controlling integrated module 10. The control code saving unit 11 in the controlling integrated module 10 responds the secondary request signal 221b with a secondary control code 111b in the signal transfer controller 20. Through the signal transfer controller 20 the secondary control code 111b is sent in a wireless fashion to the home appliance 30a to do control operation.

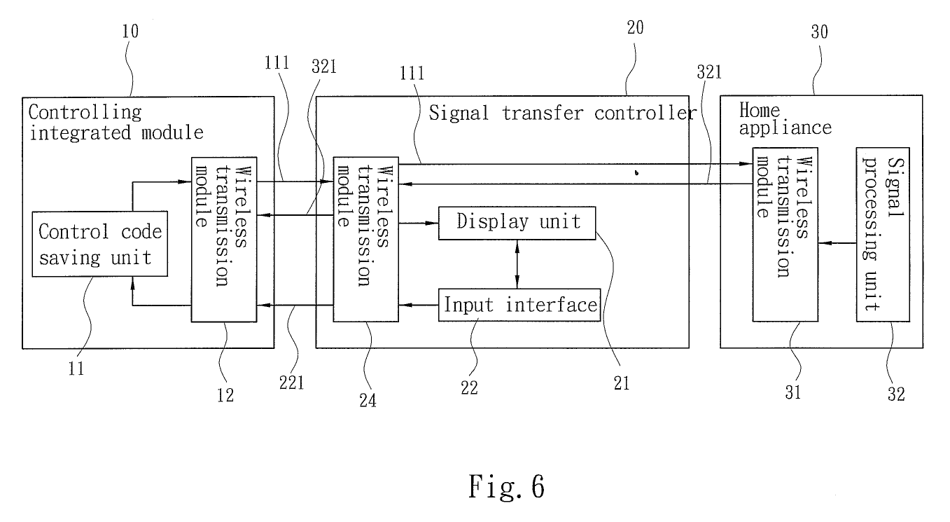

The home appliance 30 and the controlling integrated module 10 may also have two-way communication between them as shown in FIG. 6 in another embodiment of the invention. The home appliance 30 (such as an image monitoring system or security surveillance system) has a signal processing unit 32 to generate a feedback signal 321. Through the signal transfer controller 20, the feedback signal 321 can be sent to the controlling integrated module 10 in a wireless transmission mode. In addition, through the wireless transmission mode, the display unit 21 can get video information from the home appliance 30 readable by users. The feedback signal 321 generated by the signal processing unit 32 and the feedback signal 321 received by the controlling integrated module 10 may be the same, or a first feedback signal and a second feedback signal that are different. If they are different, they can be converted through a control code conversion unit located in the signal transfer controller 20.

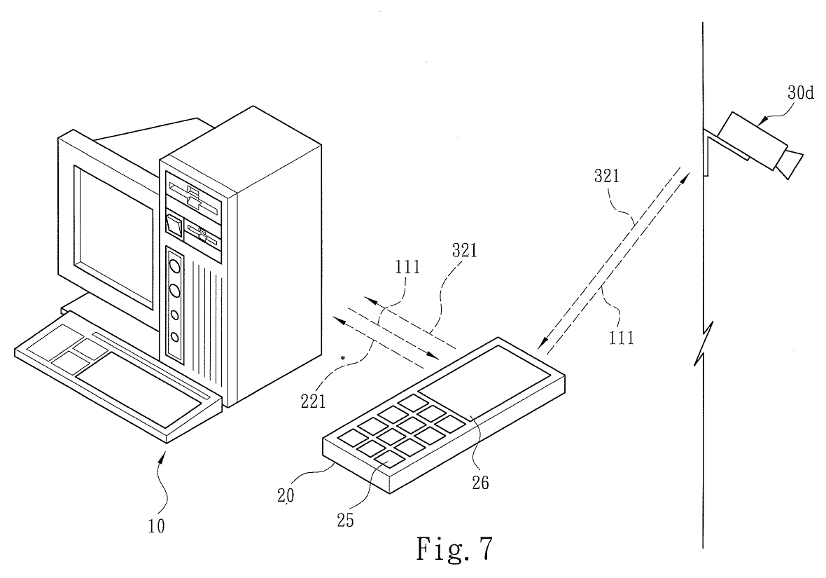

When the invention is adopted on a surveillance system as shown in FIG. 7, the home appliance 30d is a monitoring video camera to receive the control code 111 through the signal transfer controller 20 to do operations such as start, stop, angle adjustment and the like. The home appliance 30d can also send the feedback signal 321 (such as recoded images) to the signal transfer controller 20 through the signal processing unit 32 to be saved or processed. Thus a two-way communication can be established between the home appliance 30d and the controlling integrated module 10.

As a conclusion, the wireless home control system of the invention can perform remote and wireless control of multiple home appliances through a single signal transfer controller. Through the signal transfer controller, the control code of the controlling integrated module can be sent to the home appliances. The signal transfer controller does not have to store the control code. Thus there is no need to load complicated electronic elements to control multiple home appliances as the conventional universal remote controller does. In addition, a two-way communication can be established between the home appliances and the controlling integrated module through the signal transfer controller. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wireless home control system providing a control code to perform wireless operational control of at least one home appliance, comprising:
a controlling integrated module which has a control code saving unit to store the control code; and
a signal transfer controller which links the home appliance and the controlling integrated module in a wireless transmission mode and includes a display unit and an input interface linking to the display unit, the input interface generating a request signal sent to the controlling integrated module to receive the corresponding control code in the control code saving unit, the control code being sent to the home appliance through the signal transfer controller in the wireless transmission mode to perform the operation control of the home appliance.

2. The wireless home control system of claim 1, wherein the display unit and the input interface are integrated to become a touch screen.

3. The wireless home control system of claim 1, wherein the input interface is a physical control key.

4. The wireless home control system of claim 1, wherein the control code includes a first control code output to the home appliance and a second control code obtained from the control code saving unit, the first control code and the second control code are converted through a control code conversion unit located in the signal transfer controller.

5. The wireless home control system of claim 1, wherein the display unit gets video information in the wireless transmission mode from the controlling integrated module.

6. The wireless home control system of claim 1, wherein the home appliance has a signal processing unit to generate a feedback signal which is sent in the wireless transmission mode through the signal transfer controller to the controlling integrated nodule.

7. The wireless home control system of claim 6, wherein the feedback signal includes a first feedback signal generated by the signal processing unit and a second feedback signal obtained by the controlling integrated module, the first feedback signal and the second feedback signal being converted by a control code conversion unit located in the signal transfer controller.

8. The wireless home control system of claim 1, wherein the display unit receives video information from the home appliance in the wireless transmission mode.

9. The wireless home control system of claim 1, wherein the controlling integrated module is located in a computer system.

10. The wireless home control system of claim 1, wherein the signal transfer controller is a mobile communication device.

11. The wireless home control system of claim 1, wherein the signal transfer controller is a portable electronic device.
